(19) United States
(12) Patent Application Publication
(10) Pub. No.: US 2025/0027799 A1
(43) Pub. Date: Jan. 23, 2025

(54) Triboelectric Instrument, and Dust Removal System and Monitoring Method, Device, and Apparatus Therefor

(71) Applicant: Reachclean Engineering and Technical Chengdu Co., Ltd., Chengdu (CN)

(72) Inventor: Xianfeng TAN, Chengdu (CN)

(21) Appl. No.: 18/908,674

(22) Filed: Oct. 7, 2024

Related U.S. Application Data
(63) Continuation of application No. 18/031,334, filed on Apr. 11, 2023.

(30) Foreign Application Priority Data
Oct. 13, 2020 (CN) 202011089814.9
Oct. 13, 2021 (WO) PCT/CN2021/123506

(51) Int. Cl. G01F 1/64; G01N 15/06; H02N 1/04

(52) U.S. Cl. CPC G01F 1/64; G01N 15/0656; H02N 1/04

(57) ABSTRACT

A triboelectric probe (100), and a dust removal system and a monitoring method, device, and apparatus therefor, being used for solving the technical problem of reducing the number of triboelectric probes (100) used for different independent detection regions. The triboelectric probe (100) comprises a probe (110); the probe (110) comprises a sensing part (111) which comprises at least two sensing elements (111a) connected to form a current path or being separated, the at least two sensing elements (111a) are used for being respectively arranged in different independent detection regions of a target space, and when particles in any independent detection region pass through the corresponding sensing element (111a), a current signal is generated on the corresponding sensing element (111a); and the probe (110) also comprises an output part (112) which is simultaneously connected to and conducted with the at least two sensing elements (111a) separated in the sensing part (111) or is served by any one sensing element (111a) among the at least two sensing elements (111a) in the sensing part (111) which are connected to form a current path, and is used for outputting a current signal generated by each sensing element (111a) in the sensing part (111). The improved triboelectric probe (100) can detect different independent detection regions.

### CROSS-REFERENCE TO RELATED APPLICATIONS

This application is a continuation of U.S. patent application Ser. No. 18/031,334, filed on Apr. 11, 2023 (Attorney Docket No. 38371.605US), which is a national phase application of PCT Application PCT/CN2021/123506, filed on Oct. 10, 2021, which claimed the benefit of priority to Chinese Patent Application No. CN 202011089814.9 filed on Oct. 13, 2020, the entire contents of which are hereby incorporated by reference herein.

### TECHNICAL FIELD

Examples disclosed in the description relate to a triboelectric probe, a dust removal system, a monitoring method for a dust removal system, a monitoring device for a dust removal system, a monitoring apparatus for a dust removal system, and a computer-readable storage medium respectively.

### BACKGROUND ART

A triboelectric probe, or called as a triboelectric sensor, detects, by means of micro-charge sensing, particles (solid particles or liquid particles) in air flow, to obtain information such as particle flow, of which a representative product on the market is a TRIBO series product of Auburn systems. The triboelectric probe mainly includes a probe and a signal processing system. When the probe is inserted into a target space during use and particles in the target space pass through the probe, a current signal is generated and output as an input signal of the signal processing system; and the signal processing system obtains the information such as the particle flow by processing the input signal.

Presently, the probe and the signal processing system of the triboelectric probe are in one-to-one correspondence. For example, in a triboelectric probe disclosed in patent document with U.S. Pat. No. 5,448,172, a probe is connected to a signal processing system consisting of circuit modules such as a converter means and a processor by means of a triaxial cable. Therefore, when it is necessary to utilize the triboelectric probe to monitor particles in gas, of which dust is removed, output from each of dust removal unit groups in a dust removal system including a plurality of dust removal unit groups, it is necessary to arrange different triboelectric probes in the dust removal system, to detect different independent detection regions respectively, resulting in a high cost of using the triboelectric probe.

### SUMMARY

The objective of examples disclosed in the description is to provide a triboelectric probe, a dust removal system, a monitoring method for a dust removal system, a monitoring device for a dust removal device, a monitoring apparatus for a dust removal system, and a computer-readable storage medium, being used for solving the technical problem of reducing the number of triboelectric probes used for different independent detection regions.

According to one aspect of the description, a triboelectric probe is provided. The triboelectric probe includes a probe, where when the probe is inserted into a target space during use and particles in the target space pass through the probe, a current signal is generated and output as an input signal of a signal processing system, the probe includes: a sensing part which includes at least two sensing elements connected to form a current path or being separated, the at least two sensing elements are used for being respectively arranged in different independent detection regions of the target space, and when particles in any independent detection region pass through the corresponding sensing element, a current signal is generated on the corresponding sensing element; and the probe also includes an output part which is simultaneously connected to and conducted with the at least two sensing elements separated in the sensing part or is served by any one sensing element among the at least two sensing elements in the sensing part which are connected to form a current path, and is used for outputting the current signal generated by each sensing element in the sensing part.

According to an example of the triboelectric probe provided in the description, during use, different independent detection regions correspond to different execution mechanisms respectively, starting of any one of different execution mechanisms uniquely causes possibility of a change of particle characteristics in the corresponding one of different independent detection regions, and any two execution mechanisms in different execution mechanisms operate at a staggered time.

According to one aspect of the description, a dust removal system is provided. The dust removal system includes: a dust removal unit group including at least two dust removal units, each of the at least two dust removal units being provided with an independent clean gas tank, and the independent clean gas tanks forming a clean gas space; and a triboelectric probe including a probe inserted into the clean gas space and generating and outputting a current signal when particles in the clean gas space pass, and a signal processing system using the current signal as an input signal, the probe including: a sensing part which includes at least two sensing elements connected to form a current path or being separated, the at least two sensing elements being used for being respectively arranged in different independent detection regions of the target space, and when particles in any independent detection region pass through the corresponding sensing element, a current signal being generated on the corresponding sensing element; and an output part which is simultaneously connected to and conducted with the at least two sensing elements separated or is served by any one sensing element among the at least two sensing elements in the sensing part which are connected to form a current path, and is used for outputting the current signal generated by each sensing element in the sensing part.

According to an example of the dust removal system provided in the description, each of the at least two dust removal units is a dust removal unit for physically intercepting the particles in air flow by means of a filter element, and the dust removal units are each provided with a blowback system for blowback regeneration of the filter elements of the dust removal units; and the blowback system of any one of the at least two dust removal units and the blowback systems of the remaining dust removal units in the at least two dust removal units operate at different time.

According to one aspect of the description, a monitoring method for a dust removal system is provided. The monitoring method includes: obtaining blowback information of at least two dust removal units, an operation opportunity of a blowback system of each of the at least two dust removal units being capable of being determined by means of the blowback information; obtaining output information of a signal processing system of a triboelectric probe, a change of instantaneous flow of particles detected by the triboelectric probe with time being capable of being determined by means of the output information; and determining, according to the blowback information and the output information, the dust removal unit that correspondingly operates the blowback system when the instantaneous flow of the particles detected by the triboelectric probe is abnormally increased, and then sending a notification pointing to abnormality in the dust removal unit.

According to one aspect of the description, a monitoring device for a dust removal system is provided. The monitoring device is used for the example of the above dust removal system, and includes: a first information obtaining module used for obtaining blowback information of at least two dust removal units, an operation opportunity of a blowback system of each of the at least two dust removal units being capable of being determined by means of the blowback information; a second information obtaining module used for obtaining output information of a signal processing system of a triboelectric probe, a change of instantaneous flow of particles detected by the triboelectric probe with time being capable of being determined by means of the output information; and an abnormality determination notification module determining, according to the blowback information and the output information, the dust removal unit that correspondingly operates the blowback system when the instantaneous flow of the particles detected by the triboelectric probe is abnormally increased, and then sending a notification pointing to abnormality in the dust removal unit.

According to one aspect of the description, a monitoring apparatus for a dust removal system is provided. The monitoring apparatus includes: at least one processor, at least one memory, and a computer program instruction stored in the memory, where the computer program instruction, when executed by the processor, implements the above monitoring method for a dust removal system.

According to one aspect of the description, a computer-readable storage medium is provided. The computer-readable storage medium includes a stored program, where the program executes the above monitoring method for a dust removal system at runtime.

With improvement of the probe of the triboelectric probe, the probe which may only be used in one independent detection region originally is divided into different sensing elements which are simultaneously distributed in different independent detection regions, during use, different sensing elements output the current signal to the signal processing system by means of the same output part, and therefore the improved triboelectric probe may detect different independent detection regions, thereby reducing the number of the triboelectric probes used, and reducing a use cost.

Since the current signal generated on the probe is output to the signal processing system by means of the same output part, the output signal of the signal processing system may be used for representing the particle flow, etc. in different independent detection regions in which the sensing elements of the probe are distributed. However, when different independent detection regions correspond to different execution mechanism respectively, starting of any one of different execution mechanism uniquely causes possibility of the change of the particle characteristics in the corresponding one of different independent detection regions, and any two execution mechanisms in different execution mechanisms operate at a staggered time, and in this case, the output signal of the signal processing system may be used for representing the particle flow, etc. of each of different independent detection regions in which the sensing elements of the probe are distributed.

The examples disclosed in the description will be further described below with reference to accompanying drawings and particular embodiments. Additional aspects and advantages of the examples provided in the description will be set forth partially in the following description, which will become obvious in the following description, or may be learned by practice of the examples provided in the description.

### BRIEF DESCRIPTION OF THE DRAWINGS

The accompanying drawings, which form part of the description, are used for assisting in the understanding of related examples, and the contents provided in the accompanying drawings and the related description in the description can be used for explaining the related examples, but are not to be construed as unduly limiting the related examples. In the figures:

FIG. 1 is a schematic structural diagram of an example of a dust removal system provided in the description.

FIG. 2 is a schematic structural diagram of an example of a dust removal system provided in the description.

FIG. 3 is a schematic structural diagram of an example of a monitoring method for a dust removal system provided in the description.

FIG. 4 is a schematic structural diagram of an example of a monitoring device for a dust removal system provided in the description.

FIG. 5 is a schematic structural diagram of an example of a monitoring apparatus for a dust removal system provided in the description.

### DETAILED DESCRIPTION OF THE EMBODIMENTS

Examples disclosed in the description are clearly and completely described below in conjunction with the accompanying drawings. Those of ordinary skill in the art will be able to implement the examples provided in the description on the basis of the descriptions. Before the examples disclosed in the description are described in conjunction with the accompanying drawings, it should be particularly noted that
the technical solutions and the technical features provided in each part in the description, including the following description, can be combined with each other without conflict.

The content involved in the following description usually only relates to part of examples disclosed in the description, rather than all examples. Therefore, on the basis of the examples disclosed in the description, all other examples obtained by those of ordinary skill in the art without creative work should fall within the scope of protection required by the corresponding examples of the description.

The terms “including”, “including”, “having”, and any variations thereof in the description, the claims and related parts are intended to cover non-exclusive inclusion.

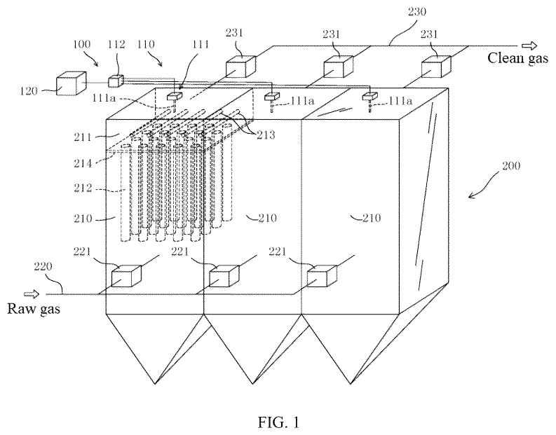

FIG. 1 is a schematic structural diagram of an example of a dust removal system provided in the description. In FIG. 1, in order to facilitate viewing and understanding, dashed lines are used for describing an internal structure of a dust removal unit 210 on the leftmost side. It is easy to understand that other dust removal units 210 also have the same or similar internal structure if required. In addition, the number of dust removal units 210 in FIG. 1 is only for illustrative purposes, and may be 2, 3, 4, or more in actual implementation.

As shown in FIG. 1, a dust removal system includes a dust removal unit group 200 and a triboelectric probe 100. The dust removal unit group 200 includes at least two dust removal units 210, each of the at least two dust removal units 210 being provided with an independent clean gas tank 211, and the independent clean gas tanks 211 forming a clean gas space. It should be noted that in the absence of other limitations, the independent clean gas tank need not be understood as a clean gas tank isolated from other clean gas tanks.

The triboelectric probe 100 includes a probe 110 inserted into the clean gas space and generating and outputting a current signal when particles in the clean gas space pass, and a signal processing system 120 using the current signal as an input signal. The probe 110 includes a sensing part 111 and an output part 112.

The sensing part 111 includes at least two sensing elements 111a being separated. The at least two sensing elements 111a are used for being respectively arranged in different independent clean gas tanks 211, and when particles in air flow of any one of the independent clean gas tanks 211 pass through the corresponding sensing element 111a, a current signal is generated on the corresponding sensing element.

The output part 112 is simultaneously connected to and conducted with the at least two sensing elements 111a separated in the sensing part 111, and is used for outputting the current signal generated by each sensing element 111a in the sensing part 111.

The signal processing system 120 may be a signal processing system capable of obtaining an output signal for representing particle flow according to the input signal.

The current signal may include a contact current signal generated on the probe when the particles make contact with the sensing probe and a sensed current signal generated on the probe when the particles pass by the probe.

The above definitions for the signal processing system and the current signal are all existing technologies in an existing triboelectric probe, and are widely used in a product such as a TRIBO series product of Auburn systems, which is thus not repeated.

With improvement of the probe of the triboelectric probe 100, the probe 110 which may only be used in one independent clean gas tank 211 originally is divided into different sensing elements 111a which are simultaneously distributed in different independent clean gas tanks 211, during use, different sensing elements 111a output the current signal to the signal processing system 120 by means of the same output part 112, and therefore the improved triboelectric probe 100 may detect different independent clean gas tanks 211, thereby reducing the number of the triboelectric probes used, and reducing a use cost.

The output signal of the signal processing system 120 of the above triboelectric probe 100 may be used for representing the particle flow of different independent clean gas tanks 211 as a whole (i.e., whole clean gas space) distributed on the sensing element 111a of the probe 110 of the triboelectric probe 100. In this case, the signal processing system of a conventional triboelectric probe may be achieved.

As shown in FIG. 1, each of the at least two dust removal units 210 is a dust removal unit for physically intercepting the particles in air flow by means of a filter element 212, and the dust removal units 210 may further be each provided with a blowback system for blowback regeneration of the filter elements 212 of the dust removal units; and the blowback system of any dust removal unit 210 of the at least two dust removal units 210 and the blowback systems of the remaining dust removal units 210 in the at least two dust removal units 210 operate at different time.

Specifically, the filter element 212 may be various components made of permeable materials (e.g., expanded polytetrafluoroethylene and porous ceramic) such as a bag and a filter cartridge. Blowback regeneration is a customary means to restore permeability of the filter element 212 by the dust removal unit, and is widely used in a filter such as a bag-type dust remover and a cartridge-type dust remover that physically intercept particles in air flow by means of the filter element.

When any one of the filter elements 212 is damaged, blowback regeneration of the filter element tends to cause exposure of a damaged portion on the filter element, thereby causing sudden increase in particle concentration in the clean gas tank 211 of the corresponding dust removal unit 210. In addition, damage of the filter element 212 is also prone to particle deposition in the clean gas tank 211 of the corresponding dust removal unit 210, and increase in particle concentration in the corresponding clean gas tank 211 is also caused during blowback regeneration.

Since the blowback system of any dust removal unit 210 of the at least two dust removal units 210 and the blowback systems of the remaining dust removal units 210 of the at least two dust removal units 210 operated at different time, if the output signal of the signal processing system 120 of the above triboelectric probe 100 reflects sudden increase in particle concentration at corresponding time of operation of the blowback system of a certain dust removal unit 210, the dust removal unit 210 of which the filter element may be damaged may be positioned.

As shown in FIG. 1, in an example of the above dust removal system, each dust removal unit 210 of the at least two dust removal units 210 of the dust removal unit group 200 is a bag-type dust remover. In each bag-type dust remover, the filter element 212 uses a bag, and a plurality of bag are suspended below a pore plate 214 in the bag-type dust remover. The independent clean gas tank 211 is arranged above the pore hole 214, and a raw gas tank is arranged above the pore plate 214. The raw gas tanks of each of the bag-type dust removers are connected to an air inlet pipe 220 by means of corresponding air inlet valves 221 respectively, and the clean gas tanks 211 of each of the bag-type dust removers are connected to an exhaust pipe 230 by means of corresponding exhaust valves 231 respectively. The blowback system of each of the bag-type dust removers includes a blow pipe 213, a pulse valve, an air bag and a control system, where each blow port spaced on each of blow pipes 213 corresponds to a port at an upper end of each of bags in a row of bags, each of blow pipes 213 is connected to the corresponding air bag by means of one pulse valve, and the control system is mainly used for controlling opening and closing of the pulse valve.

As shown in FIG. 1, in the example, the specific structure and mounting mode of the triboelectric probe 100 are as follows: the at least two sensing elements 111a of the sensing part 111 of the probe 110 of the triboelectric probe 100 are each inserted into the corresponding independent clean gas tank 211, one end of each sensing element 111a of the at least two sensing elements 111a is mounted at a top of the corresponding independent clean gas tank 211 by means of an insulating component, and the insulating component insulates the sensing element 111a from a housing of the independent clean gas tank 211. Each sensing element 111a of the at least two sensing elements 111a is connected to the same current signal output terminal (i.e. output part 112) by means of a cable (e.g. triaxial cable in patent document with patent No. U.S. Pat. No. 5,448,172), and is connected to the signal processing system 120 by means of the same current signal output terminal.

The function of the current signal output terminal is, on one hand, to connect output ends of cables of the at least two sensing elements 111a to the same conductor, and on the other hand, to connect the conductor to the signal processing system 120. The signal processing system 120 includes a transmitter (the function is to convert a raw current signal into a standard industry signal, such as 4-20 milliampere current or 1-5 volt voltage).

When the above dust removal unit group 200 operates, gas (raw gas) of which dust is to be removed enters the raw gas tank from the air inlet pipe 220 and the air inlet valve 221, and then is filtered by the bag in the raw gas tank, and filtered gas (clean gas) of which dust is removed enters the corresponding independent clean gas tank 211, and then is output through the exhaust valve 231 and the exhaust pipe 230. A process of blowback regeneration of each of the bag-type dust remover is as follows: when blowback regeneration is required for any one of the bag-type dust removers, the exhaust valve 231 corresponding to the bag-type dust remover requiring blowback regeneration is closed, and then the control system controls the pulse valves of the bag-type dust remover requiring blowback regeneration to be sequentially opened. When one pulse valve is opened, compressed gas in the corresponding air bag is quickly blown of each blow port of the corresponding blow pipe 213 and enters the corresponding bag for blowback regeneration of the bag. After blowback regeneration of one bag-type dust remover is completed, the exhaust valve 231 of the bag-type dust remover is opened anew, and then the above mode is repeated for blowback regeneration of another bag-type dust remover. It may be seen that the blowback system of any one of the bag-type dust removers and the blowback systems of the remaining bag-type dust removers in the above dust removal system operate at different time.

When any one of the bags is damaged, blowback regeneration of the bag tends to cause exposure of a damaged portion on the bag, thereby causing sudden increase in particle concentration in the clean gas tank 211 of the corresponding bag-type dust remover. In addition, damage of the bag is also prone to particle deposition in the clean gas tank 211 of the corresponding bag-type dust remover, and increase in particle concentration is also caused during blowback regeneration. The triboelectric probe 100 may instantaneously detect abnormality in particle flow when the exhaust valve 231 corresponding to the clean gas tank 211 having increased particle concentration is opened, and match the abnormality and the corresponding exhaust valve 231 to position the corresponding bag-type dust remover.

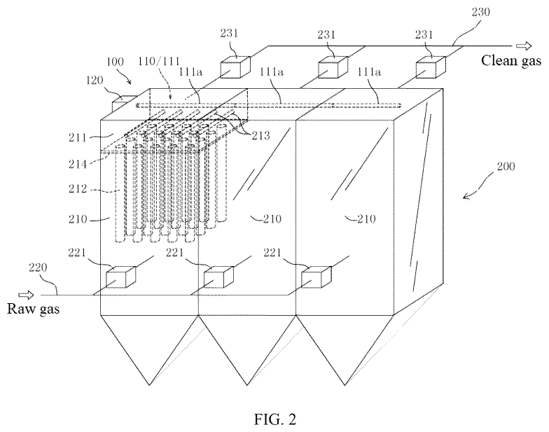

FIG. 2 is a schematic structural diagram of an example of a dust removal system provided in the description. In FIG. 2, in order to facilitate viewing and understanding, dashed lines are used for describing an internal structure of a dust removal unit 210 on the leftmost side. It is easy to understand that other dust removal units 210 also have the same or similar internal structure if required. In addition, the number of dust removal units 210 in FIG. 2 is only for illustrative purposes, and may be 2, 3, 4, or more in actual implementation.

As shown in FIG. 2, a dust removal system includes a dust removal unit group 200 and a triboelectric probe 100. The dust removal unit group 200 includes at least two dust removal units 210, each of the at least two dust removal units 210 being provided with an independent clean gas tank 211, and the independent clean gas tanks 211 forming a clean gas space.

The triboelectric probe 100 includes a probe 110 inserted into the clean gas space and generating and outputting a current signal when particles in the clean gas space pass, and a signal processing system 120 using the current signal as an input signal. The probe 110 includes a sensing part 111 and an output part.

The sensing part 111 includes at least two sensing elements 111a connected to form a current path. The at least two sensing elements 111a are respectively arranged in different independent clean gas tanks 211, and when particles in air flow of any one of the independent clean gas tanks 211 pass through the corresponding sensing element 111a, a current signal is generated on the corresponding sensing element.

The output part is served by any one sensing element 111a among the at least two sensing elements 111a connected to form the current path in the sensing part 111, and is used for outputting the current signal generated by each sensing element 111a in the sensing part 111.

Similarly, the signal processing system 120 may be a signal processing system capable of obtaining an output signal for representing particle flow according to the input signal. The current signal may include a contact current signal generated on the probe when the particles make contact with the sensing probe and a sensed current signal generated on the probe when the particles pass by the probe.

Generally, the probe 110 is configured as a linear structure forming the current path, the at least two sensing elements 111a are sectionally formed in a length direction of the linear structure; and on this basis, the probe 110 is transversely inserted between different independent clean gas tanks 211 of the at least two dust removal units 210 in a penetrating manner. Preferably, the linear structure is formed by an integrated wire or guide rod.

In addition, one end of the probe 110 may further be insulated and movably connected to a clean gas tank wall of one independent clean gas tank 210, and the other end of the probe 110 as a current signal output terminal of the output part extends out of a clean gas tank wall of another independent clean gas tank 210. Thus, the probe 110 may be stably mounted in the clean gas space.

It may be seen that with improvement of the probe of the triboelectric probe 100, the probe 110 which may only be used in one independent clean gas tank 211 originally is divided into different sensing elements 111a which are simultaneously distributed in different independent clean gas tanks 211, during use, different sensing elements 111a output the current signal to the signal processing system 120 by means of the same output part (i.e. another sensing element 111a directly connected to the signal processing system 120), and therefore the improved triboelectric probe 100 may detect different independent clean gas tanks 211, thereby reducing the number of the triboelectric probes used, and reducing a use cost.

In addition, since the probe 110 is configured as the linear structure forming the current path and the at least two sensing elements 111a are sectionally formed in the length direction of the linear structure, a structure of the probe 110 is effectively simplified.

Obviously, if clean gas tank walls of different independent clean gas tanks 211 that need to penetrate the current path are electrically conductive, it is necessary to arrange an insulating sealing sleeve sleeving an outer side of the current path on the clean gas tank wall.

In addition, if different independent clean gas tanks 211 are separated, the current path may make contact with an external environment in an region penetrating different independent clean gas tanks 211, it is necessary to provide a necessary protective measure on the outer side of the current path that may make contact with the external environment, so as to isolate contact between the current path and the external environment. The protective measure may be the insulating sealing sleeve.

As shown in FIG. 2, in an example of the above dust removal system, each dust removal unit 210 in the at least two dust removal units 210 of the dust removal unit group 200 is a cartridge-type dust remover, and the cartridge-type dust removers are arranged in a row and make contact with one another. In each cartridge-type dust remover, the filter element 212 uses a filter cartridge, and the plurality of filter cartridges are suspended below a pore plate 214 in the cartridge-type dust remover. The independent clean gas tank 211 is arranged above the pore plate 214, and a raw gas tank is arranged below the pore plate 214. The raw gas tanks of each of the cartridge-type dust removers are connected to an air inlet pipe 220 by means of corresponding air inlet valves 221 respectively, and the clean gas tanks 211 of each of the cartridge-type dust removers are connected to an exhaust pipe 230 by means of corresponding exhaust valves 231 respectively. The blowback system of each of the cartridge-type dust removers includes a blow pipe 213, a pulse valve, an air bag and a control system, where each blow port spaced on each of blow pipes 213 corresponds to a port at an upper end of each of filter cartridges in a row of filter cartridges, each of blow pipes 213 is connected to the corresponding air bag by means of one pulse valve, and the control system is mainly used for controlling opening and closing of the pulse valve.

As shown in FIG. 2, in the example, the specific structure and mounting mode of the triboelectric probe 100 are as follows: the probe 110 of the triboelectric probe 100 is configured as an integrated guide rod forming the current path, the at least two sensing elements 111a are sectionally formed in the length direction of the guide rod. One end of the probe 110 is inserted from one side of the dust removal unit group 200 and penetrates different independent clean gas tanks 211, and the other end of the probe 110 is connected to the signal processing system 120 as a current signal output terminal of the output part.

A process of blowback regeneration of each of the cartridge-type dust remover is as follows: when blowback regeneration is required for any one of the cartridge-type dust removers, the exhaust valve 231 corresponding to the cartridge-type dust remover requiring blowback regeneration is closed, and then the control system controls the pulse valves of the cartridge-type dust remover requiring blowback regeneration to be sequentially opened. When one pulse valve is opened, compressed gas in the corresponding air bag is quickly blown of each blow port of the corresponding blow pipe 213 and enters the corresponding filter cartridge for blowback regeneration of the filter cartridge. After blowback regeneration of one cartridge-type dust remover is completed, the exhaust valve 231 of the cartridge-type dust remover is opened anew, and then the above mode is repeated for blowback regeneration of another cartridge-type dust remover. It may be seen that the blowback system of any one of the cartridge-type dust removers in the above dust removal system and the blowback systems of the remaining cartridge-type dust removers operate at different time.

When any one of the filter cartridges is damaged, blowback regeneration of the filter cartridge tends to cause exposure of a damaged portion on the filter cartridge, thereby causing sudden increase in particle concentration in the clean gas tank 211 of the corresponding cartridge-type dust remover. In addition, damage of the filter cartridge is also prone to particle deposition in the clean gas tank 211 of the corresponding cartridge-type dust remover, and increase in particle concentration is also caused during blowback regeneration. The triboelectric probe 100 may instantaneously detect abnormality in particle flow when the exhaust valve 231 corresponding to the clean gas tank 211 having increased particle concentration is opened, and match the abnormality and the corresponding exhaust valve 231 to position the corresponding cartridge-type dust remover.

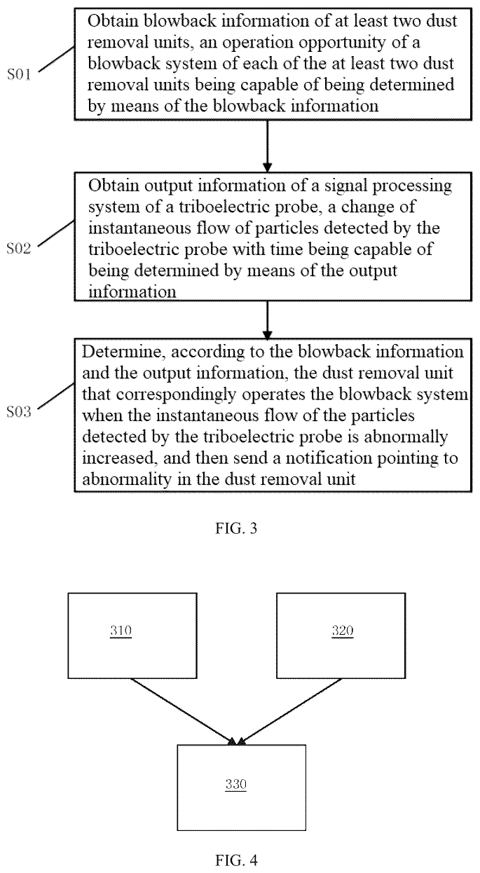

FIG. 3 is a schematic structural diagram of an example of a monitoring method for a dust removal system provided in the description. As shown in FIG. 3, a monitoring method for a dust removal system is applied to the above example of the dust removal system shown in FIG. 1 or the above example of the dust removal system shown in FIG. 2, and specifically includes:

S01, obtain blowback information of at least two dust removal units 210, an operation opportunity of a blowback system of each dust removal unit 210 of the at least two dust removal units 210 being capable of being determined by means of the blowback information.

The blowback information may be opening time of each exhaust valve 231 after the corresponding dust removal unit 210 completes blowback regeneration. When the blowback system of the dust removal unit is changed, other information that is conducive to representing operation of the blowback system of the dust removal unit may also be selected.

S02, obtain output information of a signal processing system 120 of a triboelectric probe 100, a change of instantaneous flow of particles detected by the triboelectric probe 100 with time being capable of being determined by means of the output information.

A signal processing system 120 of an existing triboelectric probe 100 is usually provided with a monitor, and the monitor may display the change of the instantaneous flow of the detected particles with time. Therefore, step S02 above may be achieved by the triboelectric probe 100.

S03, determine, according to the blowback information and the output information, the dust removal unit 210 that correspondingly operates the blowback system when the instantaneous flow of the particles detected by the triboelectric probe 100 is abnormally increased, and then send a notification pointing to abnormality in the dust removal unit.

When any bag/filter cartridge is damaged, the blowback regeneration of the bag/filter cartridge may cause increase in the concentration of the particles in the corresponding clean gas tank 211. When an exhaust valve 231 corresponding to the clean gas tank 211 having increased particle concentration is opened, the triboelectric probe 100 may instantly detect abnormality in the particle flow. After the abnormality matches the corresponding exhaust valve 231, the corresponding dust removal unit may be positioned, and the dust removal unit is an abnormal dust removal unit, such that the notification pointing to the abnormality in the dust removal unit may be sent.

Since pulse valves in each dust removal unit in the above example during blowback regeneration are sequentially opened, in order to quickly find the filter elements 212 that may be damaged in the abnormal dust removal units, after the abnormal dust removal units are determined, the pulse valves in the abnormal dust removal units are sequentially opened anew under the condition that the exhaust valves 231 corresponding to the abnormal dust removal units are opened. Moreover, the triboelectric probe 100 is used for detecting the change of the instantaneous flow of the particles with time (which is similar to the above monitoring method for a dust removal system), and then the corresponding pulse valve and a further group of filter elements 212 corresponding to a blow pipe 213 when the instantaneous flow of the particles detected by the triboelectric probe 100 is abnormally increased are searched, and broken filter elements 212 are extremely likely to be in the group of filter elements.

FIG. 4 is a schematic structural diagram of an example of a monitoring device for a dust removal system provided in the description. As shown in FIG. 4, a monitoring device for a dust removal system includes a first information obtaining module 310, a second information obtaining module 320 and an abnormality determination notification module 330.

The first information obtaining module 310 is used for obtaining blowback information of at least two dust removal units, and an operation opportunity of a blowback system of each of the at least two dust removal units may be determined by means of the blowback information.

The second information obtaining module 320 is used for obtaining output information of a signal processing system of a triboelectric probe, and a change of instantaneous flow of particles detected by the triboelectric probe with time may be determined by means of the output information.

The abnormality determination notification module 330 determines, according to the blowback information and the output information, the dust removal unit that correspondingly operates the blowback system when the instantaneous flow of the particles detected by the triboelectric probe is abnormally increased, and then sends a notification pointing to abnormality in the dust removal unit.

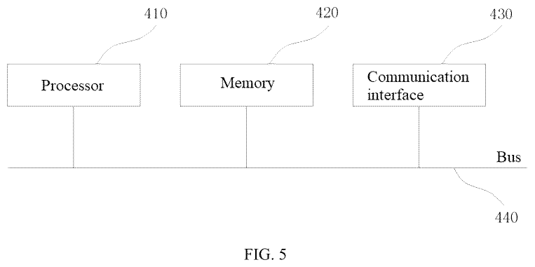

FIG. 5 is a schematic structural diagram of an example of a monitoring apparatus for a dust removal system provided in the description. as shown in FIG. 5, the monitoring apparatus for a dust removal system includes: at least one processor 410, at least one memory 420, and a computer program instruction stored in the memory, where the computer program instruction, when executed by the processor 410, implements the above monitoring method for a dust removal system.

Specifically, the processor 410 may include a central processing unit (CPU) or an application special integrated circuit (ASIC), or may be configured as one or more integrated circuits to implement the method of the present invention.

The memory 420 may include a mass memory used for data or instructions. By way of example and not limitation, the memory 420 may include a hard disk drive (HDD), a floppy disk drive, a flash memory, an optical disc, a magneto-optical disk, a tape or universal serial bus (USB) drive, or a combination of two or more of those listed above.

Where appropriate, the memory 420 may include a removable or non-removable (or fixed) medium. Where appropriate, the memory 420 may be inside or outside a data processing apparatus. In a particular example, the memory 420 is a non-volatile solid state memory.

In a particular example, the memory 420 includes a read-only memory (ROM). Where appropriate, the ROM may be a mask-programmed ROM, a programmable ROM (PROM), an erasable PROM (EPROM), an electrically erasable PROM (EEPROM), an electrically alterable ROM (EAROM) or a flash memory or a combination of two or more of those listed above.

The processor 410 implements the above monitoring method for a dust removal system by reading and executing the computer program instruction stored in the memory 420.

In an example, a monitoring apparatus for a dust removal system may further include a communication interface 430 and a bus 440. As shown in FIG. 5, the memory 410, the processor 420 and the communication interface 430 are connected and communicate with each other by means of the bus 440.

The communication interface 430 is mainly used for implementing communication among modules, apparatuses, units and/or devices. The bus 440 includes hardware, software, or both, and couples components of the monitoring apparatus for a dust removal system together. By way of example and not limitation, the bus may include an accelerate graphical port (AGP) or other graphics buses, an enhanced industry standard architecture (EISA) bus, a front side bus (FSB), hyper-transport (HT) interconnection, an industry standard architecture (ISA) bus, infiniband interconnection, a low pin count (LPC) bus, a memory bus, a micro channel architecture (MCA) bus, a peripheral component interconnect (PCI) bus, a PCI-express (PCI-X) bus, a serial advanced technology attachment (SATA) bus, a video electronics standards association local (VLB) bus, or other suitable buses or a combination of two or more those listed above. Where appropriate, the bus 440 may include one or more buses. Although the present invention describes and shows a specific bus, the present invention considers any suitable bus or interconnection.

The related contents of the examples provided in the description have been described above. Those of ordinary skill in the art will be able to implement the examples provided in the description on the basis of the descriptions. All other embodiments obtained by those of ordinary skill in the art on the basis of the above contents provided in the description without creative efforts shall fall within the scope of protection of related inventions provided in the description.

What is claimed is:

1. A triboelectric probe, comprising a probe, wherein when the probe is inserted into a target space during use and particles in the target space pass through the probe, a current signal is generated and output as an input signal of a signal processing system, and the probe comprises:
a sensing part which comprises at least two sensing elements connected to form a current path, the at least two sensing elements being used for being respectively arranged in different independent detection regions of the target space, and when particles in any independent detection region pass through the corresponding sensing element, a current signal being generated on the corresponding sensing element; and
an output part which is simultaneously connected to and conducted with the at least two sensing elements separated in the sensing part or is served by any one sensing element among the at least two sensing elements in the sensing part which are connected to form a current path, and is used for outputting the current signal generated by each sensing element in the sensing part;
wherein the probe is configured as a linear structure forming the current path, and the at least two sensing elements are sectionally formed in a length direction of the linear structure;
wherein, during use, different independent detection regions correspond to different execution mechanisms respectively, starting of any one of different execution mechanisms uniquely causes a possibility of a change of particle characteristics in the corresponding one of different independent detection regions, and any two execution mechanisms in different execution mechanisms operate at a staggered time.

2. The triboelectric probe of claim 1, wherein the linear structure is formed by an integrated wire or a guide rod.

3. The triboelectric probe of claim 1, wherein the signal processing system is a signal processing system obtaining an output signal for representing particle flow according to the input signal.

4. The triboelectric probe of claim 1, wherein the current signal comprises at least one of a contact current signal generated on the probe when the particles make contact with the probe and a sensed current signal generated on the probe when the particles pass by the probe.

5. The triboelectric probe of claim 1, wherein any one of different independent detection regions in the target space is isolated from remaining independent detection regions by means of isolation structures.

6. The triboelectric probe of claim 5, wherein an insulating sealing sleeve sleeving an outer side of the current path is arranged on the isolation structure that requires to penetrate the current path in the target space.

7. A dust removal system, comprising:
a dust removal unit group comprising at least two dust removal units, each of the at least two dust removal units being provided with an independent clean gas tank, and the independent clean gas tanks forming a clean gas space; and
a triboelectric probe comprising a probe inserted into the clean gas space and generating and outputting a current signal when particles in the clean gas space pass, and a signal processing system using the current signal as an input signal, the probe comprising:
a sensing part which comprises at least two sensing elements connected to form a current path or being separated, the at least two sensing elements being used for being respectively arranged in different independent clean gas tanks, and when particles in air flow of any independent clean gas tank pass through the corresponding sensing element, a current signal being generated on the corresponding sensing element; and
an output part which is simultaneously connected to and conducted with the at least two sensing elements separated in the sensing part or is served by any one sensing element among the at least two sensing elements in the sensing part which are connected to form a current path, and is used for outputting the current signal generated by each sensing element in the sensing part;
wherein the probe is configured as a linear structure forming the current path, the at least two sensing elements are sectionally formed in a length direction of the linear structure; and the probe is transversely inserted between different independent clean gas tanks of the at least two dust removal units in a penetrating manner;
wherein each of the at least two dust removal units is a dust removal unit for physically intercepting the particles in air flow by means of a filter element, and the dust removal units are each provided with a blowback system for blowback regeneration of the filter elements of the dust removal units; and
the blowback system of any one of the at least two dust removal units and the blowback systems of the remaining dust removal units in the at least two dust removal units operate at a different time.

8. The dust removal system of claim 7, wherein the linear structure is formed by an integrated wire or a guide rod.

9. The dust removal system of claim 7, wherein one end of the probe is insulated and is movably connected to a clean gas tank wall of one independent clean gas tank, and the other end of the probe as a current signal output terminal of the output part extends out of a clean gas tank wall of another independent clean gas tank.

10. The dust removal system of claim 7, wherein an insulating sealing sleeve sleeving an outer side of the current path is arranged on a wall of the clean gas tank which need to penetrate the current path between different independent clean gas tanks.

11. The dust removal system of claim 7, wherein the signal processing system is a signal processing system capable of obtaining an output signal for representing particle flow according to the input signal.

12. The dust removal system of claim 7, wherein the current signal comprises at least one of a contact current signal generated on the probe when the particles make contact with the sensing probe and a sensed current signal generated on the probe when the particles pass by the probe.

13. The dust removal system of claim 7, further comprising:
a monitoring device for a dust removal system, comprising:
a first information obtaining module used for obtaining blowback information of at least two dust removal units, an operation opportunity of a blowback system of each of the at least two dust removal units being capable of being determined by means of the blowback information;
a second information obtaining module used for obtaining output information of a signal processing system of a triboelectric probe, a change of instantaneous flow of particles detected by the triboelectric probe with time being capable of being determined by means of the output information; and
an abnormality determination notification module determining, according to the blowback information and the output information, the dust removal unit that correspondingly operates the blowback system when the instantaneous flow of the particles detected by the triboelectric probe is abnormally increased, and then sending a notification pointing to abnormality in the dust removal unit.
